(19) United States
(12) Patent Application Publication
(10) Pub. No.: US 2004/0176056 A1
(43) Pub. Date: Sep. 9, 2004

(54) Single-tone detection and adaptive gain control for direct-conversion receivers

(76) Inventor: Shen Feng, San Diego, CA (US)

Correspondence Address: Milan Patel, c/o Nokia Mobile Phones, Mail Stop 1-4-755, 6000 Connection Drive, Irving, TX, 75039, US

(21) Appl. No.: 10/384,009

(22) Filed: Mar. 7, 2003

(51) Int. Cl. H04B 1/00

(52) U.S. Cl. 455/130; 455/168.1

(57) ABSTRACT

Single-tone processing in a direct-conversion receiver. The receiver includes a single-tone processing circuit that adds and subtracts gain to prevent saturation of the analog baseband processing circuit as a result of a high single-tone level. The processing circuit includes a single-tone detector that receives quadrature output signals of an I/Q demodulator to detect the signal levels according to predefined signal level criteria. If detected, the detector outputs a digital sign signal that feeds an add/subtractor. The adder/subtractor receives serial input signals from external ASIC's to reduce the gain on a baseband amplifier section, and increase the gain on a following variable gain amplifier section. When the single-tone signal levels drop back to predetermined levels, the amplifier gains are reset to normal operating values.

### TECHNICAL FIELD

This invention is related to RF receivers, and more specifically, to direct-conversion receivers.

### BACKGROUND OF THE INVENTION

The idea of using direct-conversion for receivers has long been of interest in radio frequency (RF) design. Direct conversion receivers represent a key technology for cellular mobile telephones with high integration, low cost, and small size. The reason is readily apparent when considering that in consumer equipment, additional conversion stages normally not associated with direct-conversion receivers add cost, bulk, and weight. Each conversion stage requires a local oscillator, (often including a frequency synthesizer to lock the local oscillator onto a given frequency), a mixer, a filter, and possibly an amplifier. It is no wonder, then, that direct-conversion receivers are attractive, since all intermediate stages are eliminated, reducing the cost, volume, and weight of the receiver.

In RF receivers of communication systems, unwanted frequency products can exist with wanted signals at the receiver inputs. These unwanted signals can be referred to as interferers or block signals, or in mobile communication systems, single-tones. According to mobile communication regulations such as IS95/98 and IS2000, power levels of interferer products can be −30 dBm, while the wanted Code Division Multiple Access (CDMA) signals are at level as low as −101 dBm for single-tone desensitization testing of the mobile phones. Higher requirements are normally applied for integrated circuit implementation of the RF receivers, because of margin requirements in system implementations. This means the receiver RF integrated circuit (RFIC) must be capable of handling a level greater than −30 dBm during the single-tone desensitization.

In some conventional direct-conversion receiver systems, RF signals at the input of the receiver will be converted directly into baseband I/Q signals without intermediate frequencies and filtering. Channel-select filtering and gain control are carried out through an analogue baseband processor without the IF gain stages. Thus a high-order implementation in the baseband filters and a high gain range in the baseband variable gain amplifiers is required. The baseband amplifiers are designed to provide low noise and high linearity. The voltage gains of the baseband amplifiers suppress noise contribution coming from the baseband filters and variable gain amplifiers, and is also used for gain variation compensation of the overall receiver chain.

However, the voltage gains of the baseband amplifiers increases further the single-tone levels, which can saturate the output stage of the amplifiers and the filters. If the analogue baseband processor is saturated, the gain will be reduced significantly and high levels of inter-modulation products will be produced. These unwanted products distort the wanted signals in the receiver. As a result, the overall system, including a receiver RFIC and digital baseband application-specific integrated circuit devices (ASIC's), cannot correctly detect the input signals with the required low frame erasure rate (FER). Thus phone calls can be dropped.

Traditionally, increased dynamic range requirements on analogue baseband processors, such as HP3 (the theoretical input level at which the third-order two-tone distortion products are equal in power to the desired signals) and output voltage range, which is limited, were not possible due to low power supply voltage at 2.8 V or lower. In the direct-conversion receivers, single-tone levels from the RF front-end can be attenuated by 1st-order or 2nd-order low-pass filters, which can be implemented before amplification from the baseband amplifiers using passive or active components. However, this kind of low-order filtering cannot sufficiently attenuate the single-tone levels without impact on wanted signals, since the single-tone frequencies can be so close to the corner frequency of the wanted signal bandwidth. For example, in United States CDMA systems, the corner frequency is 615 kHz for the wanted signals in I- or Q-channel of the analogue baseband processor, and the lowest possible single-tone frequency is 900 kHz. Moreover, a passive implementation of the low-order low-pass filters requires external capacitors that increase the size of the printed circuit board and additional costs. An active implementation cannot provide low noise figures comparable to the integrated baseband amplifiers.

What is needed is receiver architecture that detects and compensates for high single-tone levels such that the transmission link is not dropped.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention disclosed and claimed herein, in one aspect thereof, comprises a circuit technique whereby single-tone levels can be detected and baseband gain can be controlled adaptively in order to avoid the single-tone saturation of analogue baseband processors of direct-conversion receivers.

The receiver includes a single-tone processing circuit that adds and subtracts gain to prevent saturation of the analog baseband processing circuit as a result of a high single-tone level in the received signal. The single-tone processing circuit includes a single-tone detector that receives quadrature output signals of an I/Q demodulator to detect the signal levels according to predefined signal level criteria. If not detected, the quadrature signals are processing normally in the analog baseband process circuit. However, if detected, the detector outputs a digital sign signal that is an input to add/subtractor logic. The adder/subtractor logic also receives serial input signals in the format of digit bits from external ASIC device(s) to affect the gain of amplifiers internal to the analog baseband processing circuit such that the baseband processing circuit does not saturate. More specifically, the receiver reacts adaptively to control a reduction in gain on a baseband amplifier section, and increase gain on a following variable gain amplifier section. When the single-tone signal level drops back under a predetermined level, indicating that the baseband processing circuit can operate normally without saturation, the amplifier gains are automatically reset to normal operating values.

In another aspect of the invention, there is provided a communications device having a receiver that operates in accordance with novel features of the present invention. The device includes, but is not limited to, a based station, CDMA device, and GSM device.

To the accomplishment of the foregoing and related ends, certain illustrative aspects of the invention are described herein in connection with the following description and the annexed drawings. These aspects are indicative, however, of but a few of the various ways in which the principles of the invention may be employed and the present invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 illustrates a general block diagram of the direct-conversion receiver of the present invention.

FIG. 2 illustrates a block diagram of single-tone detection and adaptive gain control in a direct-conversion receiver in accordance with the present invention.

FIG. 3 illustrates a flow chart of the process detection and correction process.

FIG. 4 illustrates a general circuit diagram of the single-tone detector with hysteresis and digital sign output.

FIG. 5 illustrates a circuit implementation of the adder/subtractor circuit for adaptive gain control.

FIG. 6 illustrates an exemplary communications device that can be employed as a cellular communications system in accordance with the subject invention.

### DETAILED DESCRIPTION OF THE INVENTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention is a circuit technique whereby single-tone levels can be detected and baseband gain can be controlled adaptively in order to avoid the single-tone saturation of analogue baseband processors of direct-conversion receivers. High single-tone levels will be detected and voltage gains of analogue baseband processor will be adjusted accordingly. Thus, saturation will be avoided and a significant improvement on the receiver performance and functionality (frame erasure rate (FER) and call drop) will be achieved without increasing dynamic range.

The invention has application for single-tone detection and adaptive gain control for direct-conversion receivers, including, but not limited to, RF systems, RFIC, RF hardware, and interfaces.

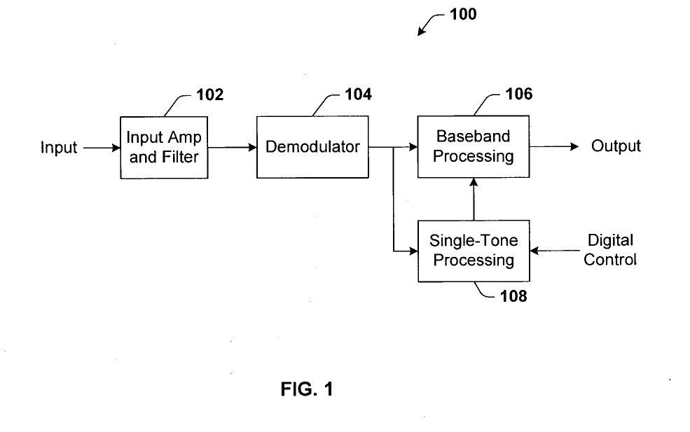

Referring now to FIG. 1, there is illustrated a general block diagram of the direct-conversion receiver 100 of the present invention. The receiver 100 receives an RF signal into an amplifier/filter component 102 where the input signal is amplified and bandpass filtered. The filtered signal is fed to a demodulator component 104 the output of which is passed in parallel to a baseband processor block 106 and a single-tone processing component 108. The output of the single-tone processing component 108 is fed back into amplifier stages of the baseband processing component 106 such that, if the single-tone processing component 108 detects a high-level signal, gain in the front-end amplifier stage of the baseband processing component 106 is digitally controlled to be reduced and gain in the output variable gain amplifier stage of the baseband processing component 106 is increased. Adaptive gain control in the context of the present invention is based upon the assumption that digital automatic gain control (AGC) is utilized in the analogue baseband processing component 106. Thus the present invention provides a circuit technique whereby single-tone levels can be detected and baseband gain can be adaptively controlled, in order to avoid the single-tone saturation of analogue baseband processors of direct-conversion receivers.

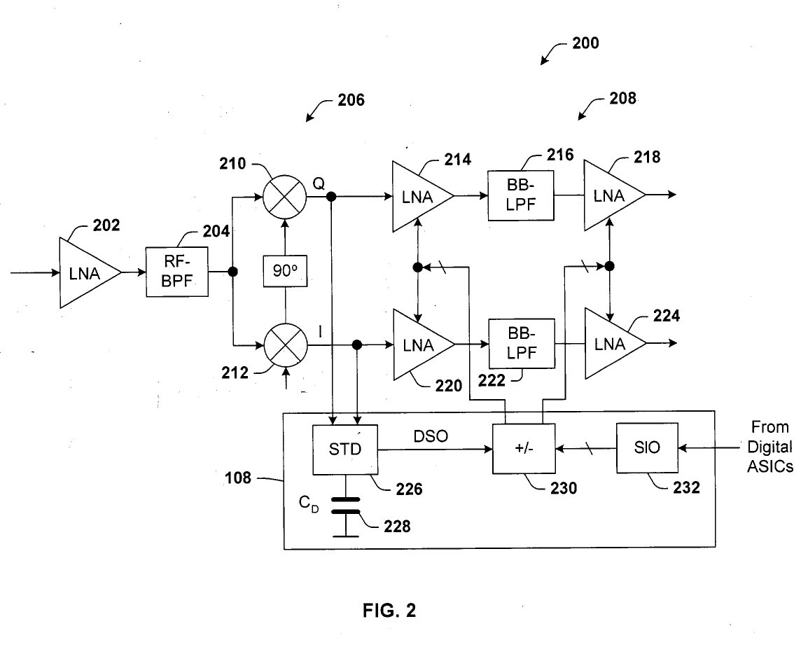

Referring now to FIG. 2, there is illustrated a block diagram of single-tone detection and adaptive gain control in a direct-conversion receiver 200 in accordance with the present invention. Illustrated herein are the general components of a CDMA direct-conversion receiver suitably configured with additional single-tone detection architecture 108. The receiver 200 includes an input LNA 202, an external RF bandpass filter 204 (denoted RF-BPF), and an I/Q demodulator 206. The receiver 200 further includes an analogue baseband processor 208. The baseband processor 208 includes baseband buffer amplifiers (214 and 220), baseband low-pass filters (216 and 222), and variable-gain amplifiers (218 and 224). A signal received at the input of the first LNA 202 is amplified for filtering through the RF filter 204. The output of the filter 204 connects to feed into the quadrature demodulator section 206 where the quadrature baseband signals are obtained.

The I/Q demodulator 206 includes a Q-channel demodulator that receives as an input the output of the RF filter 204, and whose output is fed to a second LNA 114. The output of the second LNA 214 is passed through a first baseband filter 216 and output to a third LNA 218. The I/Q demodulator 206 includes an 1-channel demodulator 212 that receives as an input the output of the RF filter 204, and whose output is fed to a fourth LNA 220. The output of the fourth LNA 220 is passed through a second baseband filter 222 and output to a fifth LNA 224.

A novel aspect of the present invention implements the single-tone processing component 108 in parallel with the analog baseband processor 208. The I/Q baseband input signals, which are down-converted from RF signals in the I/Q demodulator 206, are also fed into a single-tone detector (STD) 226. That is, the output signal of the Q-channel demodulator 210 and the output signal of the I-channel demodulator are both input to the STD 226 of the single-tone processing component 108. An output of the STD 226 connects to a digital adder/subtractor component 230, which component 230 also receives an input from a serial Input/Output (SIO) interface 232. The SIO 232 processes digital signals received from other digital control devices suitably configured to provide such control signals in furtherance of novel feature(s) of the present invention. A subtractor output of the adder/subtractor component 230 connects to pass digital gain control signals to both of the baseband amplifiers (214 and 220) to reduce the gain associated therewith, when a high single-tone level if detected. An adder output of the adder/subtractor component 230 connects to pass digital gain control signals to both of the baseband variable gain amplifiers (218 and 224) to increase the gain associated therewith, when the high single-tone level if detected. An external capacitor 228 connects from the STD block 226 to a reference plane to support filtering with filters internal to the STD block 226.

In the direct-conversion receivers with digital AGC and single-tone detection of the present invention, the voltage gains of the baseband amplifiers (214 and 220) and baseband variable gain amplifiers (218 and 224) are controlled digitally through the 3-wire SIO 232 that is normally integrated on the receiver RF integrated circuit (RFIC). For instance, three and five register bits in the SIO 232 are used for 18 dB and 72 dB gain control of the baseband amplifiers (214 and 220) and baseband variable gain amplifiers (218 and 224), respectively, in gain steps of 3 dB.

The STD block 226 generates a digital sign signal depending on the single-tone levels received into the STD block 226 and a pre-defined reference voltage level. The sign signal is used for subtraction with the digital signals (i.e., three bits) for gain control of the baseband amplifiers (214 and 220), and for addition with the digital signals (i.e., five bits) for gain control of the baseband variable gain amplifiers (218 and 224) to provide an adaptive gain adjustment. As a result, a three or six decibel gain reduction in the output of the baseband amplifiers (214 and 220) and a three or six decibel gain increase in the output of the baseband variable gain amplifiers (218 and 224) will be achieved in order to avoid single-tone saturation in the analogue baseband processor 208.

As indicated above, the gain adjustment occurs only for the period when a high level of single-tone exists. During this period, the baseband amplifiers (214 and 220) may have a lower voltage gain, and consequently, a higher noise contribution from the analogue baseband processor 208. For example, noise figures of RF receivers can be increased by approximately 0.5 dB. In other words, receiver sensitivity can be degraded by approximately 0.5 dB during this short period of time. However, receiver FER will be maintained within an acceptable level so that phone call connections will be maintained by using this adaptive gain control. After the single-tone levels drop back to a lower level than a predefined threshold, the baseband amplifiers (214 and 220) will reset back to a high gain mode between approximately 15 and 18 dB. A high sensitivity can still be obtained for the RF receivers at most times.

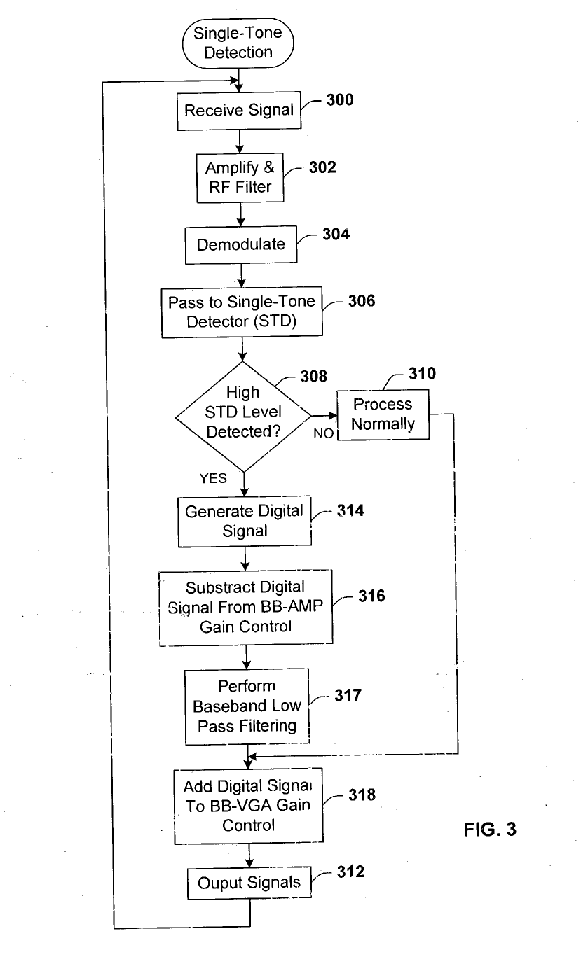

Referring now to FIG. 3, there is illustrated a flow chart of the process detection and correction process. While, for purposes of simplicity of explanation, the methodology is shown and described as a series of acts, it is to be understood and appreciated that the present invention is not limited by the order of acts, as some acts may, in accordance with the present invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 300, a transmitted signal is received into the receiver suitably configured in accordance with single-tone processing of the present invention. The signal is the amplified and filtered, as indicated at 302. At 304, the signal is demodulated using quadrature demodulation. At 306, the quadrature signals are passed in parallel to the STD for detection of a high single-tone level, and to first baseband amplifier stage the baseband processor. At 308, the STD processes the quadrature signals to determine the level in accordance with predefined signal criteria. If NO high level signal is detected within predefined signal level criteria, the receiver gain control is reset from the previous gain settings and the signals are processed normally, as indicated at 310, by utilizing the normal output processing of the baseband processor. At 312, the processed signals are then output.

If YES, a high single-tone signal level is detected, and at 314, digital sign signals are generated by the STD to effect control of gain in both the baseband amplifiers (214 and 220) and variable gain amplifiers (218 and 224). At 316, the digital signal is processed through the adder/subtractor to reduce the gains of the baseband amplifiers (214 and 220). At 317, the signals are baseband low pass filtered. At 318 digital signals are generated to increase the gains of the variable gain amplifiers (218 and 224). At 312, the processed signals are then output. Flow then returns to 300 where signal processing continues.

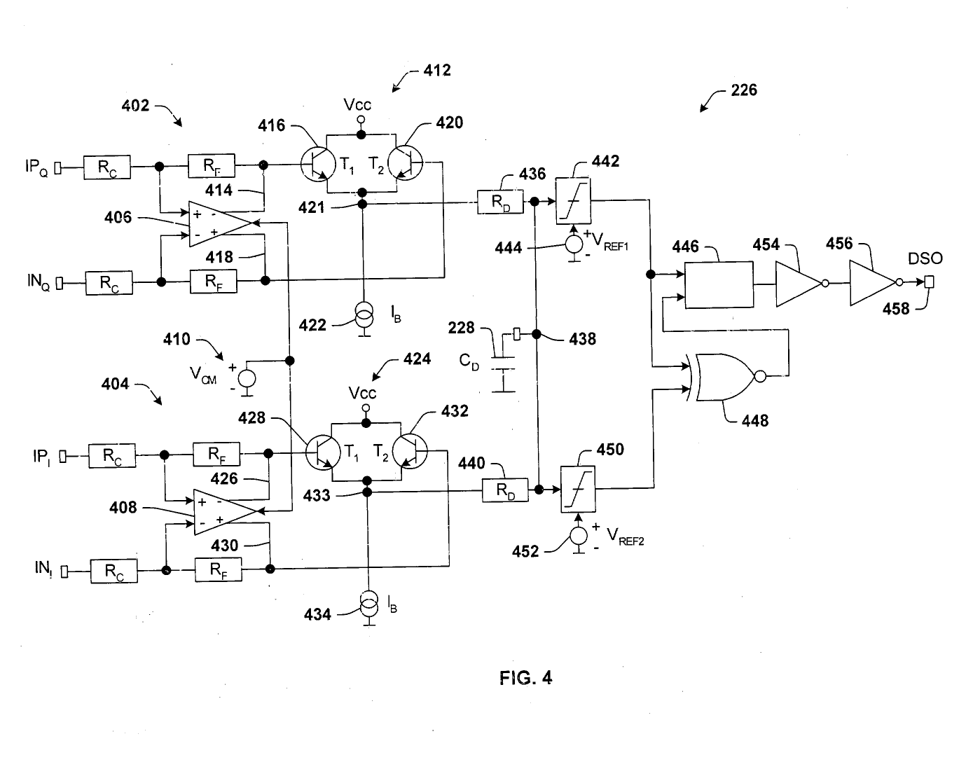

Referring now to FIG. 4, there is illustrated a general circuit diagram of the single-tone detector 226 with hysteresis and digital sign output (DSO). The detector 226 has as inputs two fully differential amplifier stages (402 and 404). The first amplifier stage 402 has an amplifier 406 that is a fully differential operational amplifier (opamp), and has as respective voltage inputs, a positive Q-channel component (denoted IP_{Q}) and a negative Q-channel component (denoted IN_{Q}). The amplifier 406 utilizes an R_{F}/R_{C} feedback resistor network (where resistor R_{C} ranges from two to eight kilohms, and resistor R_{F} ranges from ten to fifty kilohms). The second amplifier stage 404 has an amplifier 408 that is also a fully differential operational amplifier (opamp), and has as respective voltage inputs, a positive I-channel component (denoted IP₁) and a negative 1-channel component (denoted IN₁). The amplifier 408 utilizes an R_{F}/R_{C} feedback resistor network (where resistor R_{C} ranges from two to eight kilohms, and resistor R_{F} ranges from ten to fifty kilohms).

Common-mode feedback (CMF) is designed for the opamps to set required input common-mode DC voltage levels (e.g., Vcm≅1.6V to 1.9V for a 2.7 V power supply voltage level) at the inputs of the detector 226. Conversional CMF circuit techniques can be employed referencing to a fixed reference voltage 410. The reference voltage 410 can be generated using many reference voltage techniques, including for example, an integrated band gap reference circuit or a regulated supply voltage.

The first amplifier stage 402 has a detector circuit 412 that connects to its differential outputs. That is, the first amplifier 406 has a differential low output 414 that connects to the base (or switching control element) of a first transistor 416 (or switching element) of the first detector circuit 412, and a differential high output 418 that connects to the base (or switching control element) of a second transistor 420 (or switching element) of the first detector 412. The transistor emitters (or drain elements) are tied to a common node 421, which is also a constant current sink 422 for regulating the flow of current through the transistors (416 and 420).

Similarly, the second amplifier stage 404 has a detector circuit 424 that connects to its differential outputs. That is, the second amplifier 408 has a differential low output 426 that connects to the base of a first transistor 428 of the second detector circuit 424, and a differential high output 430 that connects to the base of a second transistor 432 of the second detector 424. The transistor emitters are tied to a common node 433, which is a constant current sink 434 for regulating the flow of current through the transistors (428 and 432).

The node 421 of the first detector 412 connects to one lead of a first filter resistor 436. Another lead of the resistor 436 connects to a node 438, which is a lead of the filter capacitor 228. The node 433 of the second detector 424 connects to one lead of a second filter resistor 440. Another lead of the second resistor 440 connects to the node 438, which is one lead of the filter capacitor 228.

The node 438 is electrically the same as the input to a first hysteresis element 440 and one connection of the first filter resistor 442. The first hysteresis element 440 is referenced to a common reference plane via a first reference voltage source 444 (also denoted V_{REF1}). The output of the first hysteresis element 442 connects to one input of a digital logic device 446, here a D-flip-flop (denoted DFF), and to one input of an inverted XOR logic device 448 (denoted NXOR).

The node 438 is electrically the same as the input to a second hysteresis element 450 and one connection of the second filter resistor 440. The second hysteresis element 450 is referenced to a common reference plane via a second reference voltage source 452 (also denoted V_{REF2}). The output of the second hysteresis element 450 connects to another input of the NXOR device 448.

An output of the NXOR device 448 connects to an input of the DFF 446. The output of the DFF 446 is inverted with a first logic inverter 454 and inverted again with a second logic inverter 456 to arrive at the digital sign output 458.

The detection circuit (412 or 424), which is similar to an amplitude envelope detector, consists of two NPN bipolar transistors (T1 and T2) and constant current sink (I_{B}=50 to 100 microamps). The I/Q-combined output of the two detectors (412 or 424) is filtered using two 1st-order low pass filters comprising the combination of resistor 426 and external capacitor 228, and resistor 440 and the capacitor 438. The values for the corresponding elements are the following: R_{D}≅5 to 15 kΩ and C_{D}≅5 to 15 nanofarads. The filter components (R_{D} and C_{D}) also determine the time constant of the detector 226, which can be set to approximately fifty microseconds, depending on application involving systems such as Code Division Multiple Access (CDMA) or Global System for Mobile Communications (GSM) mobile phones.

Two voltage comparators with D-flip-flops compare the output voltage (at the nodes 421 and 433) of the detection circuits (412 and 424, respectively) with the two predefined voltage references (444 and 452). The reference voltages range accordingly: V_{REF1}, ≅1.1 to 1.3 V, and V_{REF2}≅1.15 to 1.35 V, of which the voltage delta is defined as a hysteresis of V_{REF2}−V_{REF1}≅20 to 50 mV, and two digital outputs will be generated. These two digital outputs are decoded for the digital sign output signal 458 using the NXOR gate 448, DFF 446, and the two inverters (454 and 456) as output buffers. The voltage hysteresis elements (442 and 450) are needed to avoid potential oscillations, in case the output voltage of the detector 226 varies around the threshold due to fractuation of the single tone levels at the receiver input.

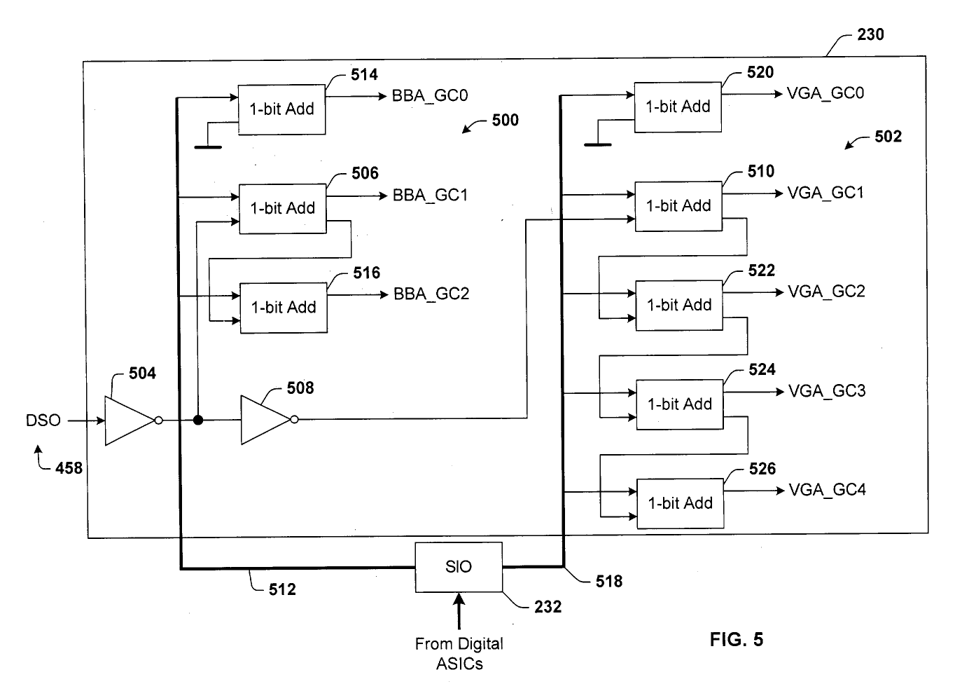

Referring now to FIG. 5, there is illustrated a circuit implementation of the adder/subtractor circuit 230 for adaptive gain control (±6 dB). The circuit 230 includes two principal sections: a first digital adder circuit 500 for the baseband amplifiers (214 and 220); and a second digital adder circuit 502 for the baseband variable gain amplifiers (218 and 224). The first adder circuit 500 includes three 1-bit adders for providing three bits of 18 dB gain control. The second adder circuit 502 includes five 1-bit adders for providing five bits of 72 dB gain control. An input to the adder/subtractor 230 is the DSO signal 458 through a first inverter 504. The output of the first inverter 504 connects to an input of a 1-bit adder 506 of the first adder circuit 500. This provides the gain control input for first adder circuit for the baseband amplifiers (214 and 220). The output of the first inverter 504 also is the input to second inverter 508. The output of the second inverter 508 connects an input of a 1-bit adder 510 of the second adder circuit 502.

The outputs of the SIO 232 are bused individually to the two adder circuits (500 and 502). Thus a first bus 512 connects as inputs to the three 1-bit adders of the first adder circuit 500: a 1-bit adder 514, the 1-bit adder 506, and a 1-bit adder 516. Similarly, a second bus 518 connects as inputs to the five 1-bit adders of the second adder circuit 502: a 1-bit adder 520, the 1-bit adder 510, a 1-bit adder 522, a 1-bit adder 524, and a 1-bit adder 526.

In order to provide 3-bit gain control from the first adder circuit 500, one input of the 1-bit adder 514 connects to a common reference point. The output of the 1-bit adder 514 is one bit of the gain control signal (BBA_GC0) for the baseband amplifiers (214 and 220). One output of the I-bit adder 506 is a second bit of the gain control signal (BBA_GC1) for the baseband amplifiers (214 and 220). Another output of the 1-bit adder 506 is fed back as an input of the 1-bit adder 516. One output of the 1-bit adder 516 is a third bit of the gain control signal (BBA_GC2) for the baseband amplifiers (214 and 220).

In order to provide 5-bit gain control from the second adder circuit 502, one input of the 1-bit adder 520 connects to the common reference point. The output of the 1-bit adder 520 is one bit of the gain control signal (VGA_GC0) for the variable gain amplifiers (218 and 224). One output of the 1-bit adder 510 is a second bit of the gain control signal (VGA_GC1) for the variable gain amplifiers (218 and 224). Another output of the 1-bit adder 510 connects as an input of the 1-bit adder 522. One output of the 1-bit adder 522 is a third bit of the gain control signal (VGA_GC2) for the variable gain amplifiers (218 and 224). Another output of the 1-bit adder 522 connects as an input of the 1-bit adder 524. One output of the 1-bit adder 524 is a fourth bit of the gain control signal (VGA_GC3) for the variable gain amplifiers (218 and 224). Another output of the 1-bit adder 524 connects as an input of the 1-bit adder 526. One output of the 1-bit adder 526 is a fifth bit of the gain control signal (VGA_GC4) for the variable gain amplifiers (218 and 224).

The adder/subtractor circuit 230 is designed with 3 dB gain steps used in the baseband amplifiers (214 and 220) and baseband variable gain amplifiers (218 and 224), and 6 dB adaptive gain adjusts in the STD 226. The SIO 232 interfaces with digital baseband application-specific integrated circuit devices (ASIC's) and provides conversion of the series signals into parallel signals to control the voltage gains of baseband amplifiers (214 and 220) and baseband variable gain amplifiers (218 and 224) in a conversional digital AGC system. The DSO signal 458 of the STD 226 is inverted and added with the 3-bit control signals from the SIO 232 using the 1-bit digital adder circuits. The control signals BBA_GC0, BBA_GC1 and BBA_GC2 are generated from the circuit 230 for the adaptive gain control. Similarly, the 5-bit control signals from the SIO 232 are added with the non-inverted DSO 458 (via inverter 508) to generate signals VGA-GC0, VGA-GC1, VGA-GC2, VGA-GC3 and VGA-GC4 for the adaptive gain control of the baseband variable gain amplifiers (218 and 224). It is to be appreciated that this circuit implementation can be applied for the amplifiers (214, 220, 218 and 224) with other gain steps, and also different adaptive gain adjusts, such as 3 dB, for example.

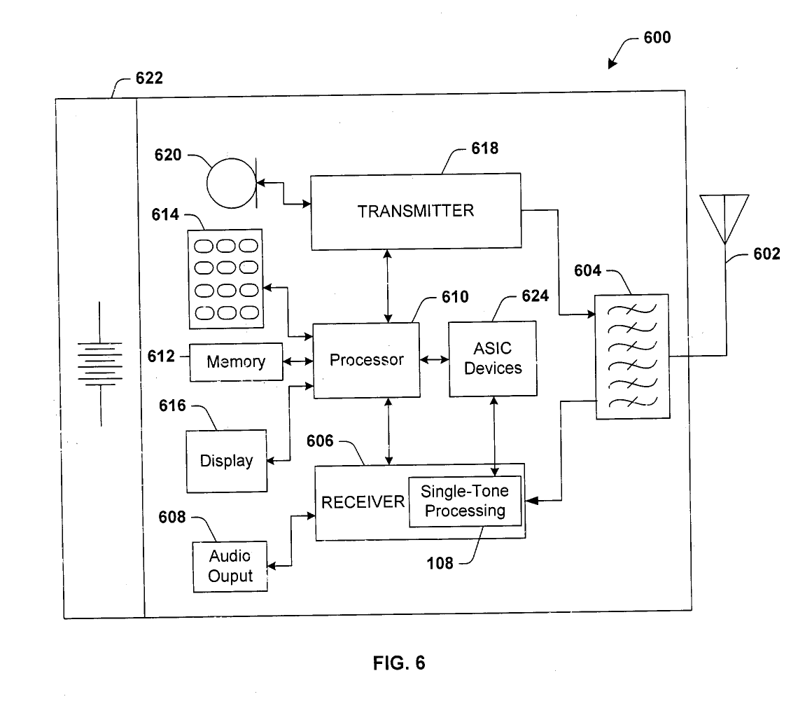

Referring now to FIG. 6, there is illustrated an exemplary communications device 600 (e.g., mobile station, CDMA wireless device, GSM device, base station) which can be employed as a cellular communications system in accordance with the subject invention. The illustrated communications device 600 comprises an antenna 602 and a connected duplex filter 604, where a signal received by the antenna 602 is directed to a receiver 606, a direct-conversion receiver that includes the single-tone processing component 108 of the present invention. The receiver 606 provides reception, down converting, demodulation, and decoding functions by which a received RF signal is converted to an analog audio signal, which is then directed to an audio output device 608, and to data signals which are directed to a processor 610. The processor 610 may be a digital signal processor suitably designed for high-speed computations normally associated with, for example, CDMA and GSM devices. The processor 610 executes necessary algorithms, and also in other ways, controls operation of the communications device 600, at least in part under directions of program(s) recorded in a memory 612, and commands input via a user input device 614 (e.g., a keypad) and system commands (e.g., transmitted via a base station). The processor 610 may also process audio signals stored in the memory 612 that are played to the user via the audio source 608 in response to various operational events that occur in the communications device 600 (e.g., turning power on and receiving a call request). The communications device 600 also includes a display 616 for presenting information to the user, e.g., echoing keypad entries, displaying information related to operational events, and presenting electronic mail text/images or associated signals that can be retrieved for presentation to the user.

The communications device 600 also includes a transmitter 618 that comprises usual coding, interleaving, modulation and upmixing functions whereby the analog audio signals received by a microphone 620 and the data signals received by the processor 610 are converted to a transmittable RF signal. In addition, the communication device 600 comprises a power source 622 for providing power to all onboard power consuming devices.

The communications device 600 also includes ASIC devices 624 in operative communication with both the processor 610 and receiver 606. The ASIC devices 624 provide the digital control signals to single-tone processing component 108 of the receiver 606.

What has been described above includes examples of the present invention. It is, of course, not possible to describe every conceivable combination of components or methodologies for purposes of describing the present invention, but one of ordinary skill in the art may recognize that many further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A direct-conversion receiver, comprising:
a demodulator for demodulating a received signal;
a baseband processing component for processing the demodulated signal; and
a single-tone processing component for controlling the baseband processing component by adaptively adjusting a baseband processing component gain to prevent saturation thereof.

2. The receiver of claim 1, the baseband process component an analog baseband processor.

3. The receiver of claim 1, the baseband processing component comprising digital automatic gain control.

4. The receiver of claim 1, the single-tone processing component receives the demodulated signal and detects whether a level of the signal has exceeded a predetermined level criteria.

5. The receiver of claim 1, the single-tone processing component receives the demodulated signal, in response to which the single-tone processing component digitally controls the baseband processing component to prevent saturation thereof.

6. The receiver of claim 1, the single-tone processing component receives the demodulated signal, in response to which the single-tone processing component generates a digital sign signal to digitally control the baseband processing component.

7. The receiver of claim 1, the single-tone processing component receives serial input signals that control the amount of baseband processing component gain in the baseband processing component.

8. The receiver of claim 1, the single-tone processing component controlling the baseband processing component by at least one of reducing the gain and increasing the gain.

9. The receiver of claim 1, the single-tone processing component controlling the baseband processing component by reducing gain in a baseband amplifier stage, and increasing gain in a subsequent variable gain amplifier stage.

10. The receiver of claim 1, the single-tone processing component further including a serial converter that converts received serial signals into parallel signals to control gain in at least one amplifier stage of the baseband processing component.

11. The receiver of claim 1, the single-tone processing component controlling the baseband processing component by reducing gain in a baseband amplifier stage according to a gain value, and increasing gain in a subsequent variable gain amplifier stage by the gain value.

12. The receiver of claim 1, the single-tone processing component including a single-tone detector that is an amplitude envelope detector with hysteresis.

13. A direct-conversion receiver, comprising:
a demodulator for demodulating a received signal;
a baseband processing component for processing the demodulated signal, the baseband processing component comprising,
a baseband amplifier stage, and
a variable gain amplifier stage;
a single-tone detector operatively connected to the baseband processing component for determining if the demodulated signal has reached a predetermined signal level; and
a digital control circuit for receiving an output of the single-tone detector and controlling the baseband amplifier stage and variable gain amplifier stage to prevent saturation of the baseband processing component.

14. The receiver of claim 13, the single-tone detector receiving the demodulated signal from the demodulator in quadrature.

15. The receiver of claim 13, the single-tone detector outputting a digital sign signal to the digital control circuit, which digital control circuit digitally reduces gain in the baseband amplifier stage and increases gain in the variable gain amplifier stage.

16. The receiver of claim 15, the gain reduced and increased in steps in accordance with register bits of the digital control circuit.

17. The receiver of claim 15, the digital sign signal outputted in accordance with at least one of a level of the demodulated signal and a predefined reference level.

18. The receiver of claim 13, the single-tone detector including a filter component having a time constant that is adjustable for implementation in at least one of CDMA and GSM devices.

19. A method controlling direct-conversion receiver, comprising:
demodulating a received signal;
processing the demodulated signal with a baseband processing component; and
controlling the baseband processing component with a single-tone processing component by adaptively adjusting a baseband processing component gain to prevent saturation thereof.

20. The method of claim 19, the baseband processing component an analog baseband processor.

21. The method of claim 19, the baseband processing component comprising digital automatic gain control.

22. The method of claim 19, the single-tone processing component receiving the demodulated signal and detecting whether a level of the signal has exceeded a predetermined level criteria.

23. The method of claim 19, the single-tone processing component receiving the demodulated signal, in response to which the single-tone processing component digitally controlling the baseband processing component to prevent saturation thereof.

24. The method of claim 19, the single-tone processing component receiving the demodulated signal, in response to which the single-tone processing component generates a digital sign signal to digitally control the baseband processing component.

25. The method of claim 19, the single-tone processing component receiving serial input signals for controlling the amount of baseband processing component gain in the baseband processing component.

26. The method of claim 19, the single-tone processing component controlling the baseband processing component by at least one of reducing the gain and increasing the gain.

27. The method of claim 19, the single-tone processing component controlling the baseband processing component by reducing gain in a baseband amplifier stage, and increasing gain in a subsequent variable gain amplifier stage.

28. The method of claim 19, the single-tone processing component further including converting received serial signals into parallel signals with a serial converter to control gain in at least one amplifier stage of the baseband processing component.

29. The method of claim 19, the single-tone processing component controlling the baseband processing component by reducing gain in a baseband amplifier stage according to a gain value, and increasing gain in a subsequent variable gain amplifier stage by the gain value.

30. The method of claim 19, the single-tone processing component including a single-tone detector that is an amplitude envelope detector with hysteresis.

31. A direct-conversion receiver, comprising:
a demodulator for demodulating a received signal;
a baseband processing component for processing the demodulated signal, the baseband processing component comprising,
a baseband amplifier stage, and
a variable gain amplifier stage;
a single-tone detector operatively connected to the baseband processing component for determining if the demodulated signal has reached a predetermined signal level; and
a digital control circuit for receiving an output of the single-tone detector and controlling the baseband amplifier stage and variable gain amplifier stage to prevent saturation of the baseband processing component.

32. The receiver of claim 31, the single-tone detector receiving the demodulated signal from the demodulator in quadrature.

33. The receiver of claim 31, the single-tone detector outputting a digital sign signal to the digital control circuit, which digital control circuit digitally reduces gain in the baseband amplifier stage and increases gain in the variable gain amplifier stage.

34. The receiver of claim 33, the gain reduced and increased in steps in accordance with register bits of the digital control circuit.

35. The receiver of claim 33, the digital sing signal outputted in accordance with at least one of a level of the demodulated signal and a predefined reference level.

36. The receiver of claim 31, the single-tone detector including a filter component having a time constant that is adjustable for implementation in at least one of CDMA and GSM devices.

37. A controlling direct-conversion receiver, comprising:
means for demodulating a received signal;
means for processing the demodulated signal; and
means for controlling the baseband processing component by adaptively adjusting a baseband processing component gain to prevent saturation thereof.

38. A communications device, comprising:
an antenna for receiving a signal;
a direct-conversion receiver for converting the received signal, the receiver comprising,
a demodulator for demodulating the received signal;
a baseband processing component for processing the demodulated signal;
a single-tone detector operatively connected to the baseband processing component for determining if the demodulated signal has reached a predetermined signal level; and
a digital control circuit for receiving an output of the single-tone detector and controlling the baseband processing component to prevent saturation thereof;
a signal processor operatively connected to the receiver for processing at least an instruction stored in the device; and
a power source for powering the device.

39. The device of claim 38, further including at least one of a display for presenting information to a user, an audio output device for generating audio signals; and a user input device.

40. The device of claim 38, the single-tone detector outputting a digital sign signal to the digital control circuit in response to the demodulated signal reaching a predetermined signal level, which digital sign signal causes the digital control circuit to reduce the gain in at least one amplifier and increase the gain in at least another amplifier.
